(19) United States
(12) Patent Application Publication
(10) Pub. No.: US 2010/0028689 A1
(43) Pub. Date: Feb. 4, 2010

(54) B-STAGE THERMAL CONDUCTIVE DIELECTRIC COATED METAL-PLATE AND METHOD OF MAKING SAME

(76) Inventors: Kam-Chuen Yung, Hong Kong (HK); Tai-Man Yue, Hong Kong (HK)

Correspondence Address: EVAN LAW GROUP LLC, 600 WEST JACKSON BLVD., SUITE 625, CHICAGO, IL, 60661, US

(21) Appl. No.: 12/183,425

(22) Filed: Jul. 31, 2008

(51) Int. Cl. B32B 15/092

(52) U.S. Cl. 428/418; 427/58

(57) ABSTRACT

A thermal conductive dielectric coated metal-plate includes a metal carrier, and a partially cured dielectric layer coated to the metal carrier. The dielectric layer includes an epoxy resin, a filler, and a coupling agent.

### BACKGROUND

The designs of electronic devices and systems are being continuously improved by becoming smaller in size and faster in communication speed. The potential risks associated with these specific design improvements include an increase in power density and, consequently, a greater risk of thermal problems and failures.

Thermal management requirements also have affected the design of power electronic products, such as motor controllers and drivers, light emitting diodes (LEDs) lighting modules, power supplies and amplifiers, and regulators for televisions. As the demands for denser and faster circuits intensify, the heat dissipation in power electronic printed circuit boards (“PCBs”) is becoming increasingly important. Effective heat dissipation is crucial to enhance the performance and reliability of electronic devices. Materials that are thermally conducting, but electrically insulating, are needed for dielectrics and substrates used in PCBs.

There are many thermal constraints associated with microelectronics and power electronic systems. For example, thermal impedance arises from the interfaces between components and the PCB, heat sink and surrounding media, as well as from the thermal interfaces at the chip packaging level. At the PCB level, thermal constraints can arise from the thermal conduction of the dielectric material.

One of the current approaches to enhance the efficiency of thermal dissipation is the use of highly thermal conductive material, such as those used in the Metal Core Printed Circuit Boards (MCPCBs). However, most thermal conductive dielectrics available on the market are single-sided laminates in a C-stage (fully cured) condition. This type of thermal conductive dielectric limits the flexibility of PCB design and the fabrication of multi-layer thermal conductive PCBs. Thus, there is a need for B-stage thermal conductive dielectrics that could provide this flexibility.

Current approach to fabricate this thermal conductive dielectric is adding inorganic filler into polymer matrix. This inorganic filler is thermally conducting, but electrically insulating. However, the advantage of adding inorganic fillers to a dielectric typically comes with disadvantages in the material properties of the dielectric. For instance, a dielectric containing an inorganic filler is typically more brittle than the unfilled dielectric. In addition, most inorganic fillers have a comparatively high dielectric constant (i.e. over 5) relative to the dielectric, which tends to increase the dielectric constant of the composite dielectric material. If the dielectric constant of the material is too high, it may limit the application of the filled dielectric.

Consequently, it is desirable to seek a method to produce B-stage thermal conductive dielectrics with a suitable carrier, and seek improvements in dielectric materials by minimizing the amount of highly thermal conductivity fillers required to achieve a particular thermal conductivity value, while maintaining or improving other crucial material properties. It is desirable to maximize the thermal dissipation effect of the electrically insulating material, while achieving excellent performance of devices that include the material.

### BRIEF SUMMARY

According to one aspect, a thermal conductive dielectric coated metal-plate includes a metal carrier, a partially cured dielectric layer coated to the metal carrier. The dielectric layer includes an epoxy resin, a filler, and a coupling agent.

According to another aspect, a method making a thermal conductive dielectric coated metal-plate includes mixing a filler with a coupling agent, adding the filler to an epoxy resin to form a varnish, coating the varnish on a metal carrier, and curing the varnish.

### BRIEF DESCRIPTION OF THE DRAWINGS

FIG. 1A depicts a SEM image of 53 nm boron nitride powders.

FIG. 1B depicts a SEM image of 0.15 μm boron nitride powders.

FIG. 1C depicts a SEM image of 4 μm boron nitride powders.

FIG. 2 depicts a process flow of preparing B—N-filled thermal conductive dielectrics.

FIG. 3 depicts the viscosity of the B—N filled epoxy composite as a function of filler content.

FIG. 4 depicts the thermal conductivity of B—N-epoxy dielectrics as a function of filler size and content.

FIG. 5 depicts a comparison of experimental data with calculation results using modified Bruggeman models.

FIG. 6A depicts a size distribution and an SEM micrograph of 53 nm B—N filler.

FIG. 6B depicts a size distribution and an SEM micrograph of 0.15 μm B—N filler.

FIG. 6C depicts a size distribution and an SEM micrograph of 4 μm B—N filler.

FIG. 7A depicts 4 μm B—N-filler.

FIG. 7B depicts a surface of an epoxy composite containing 10 wt % of 4 μm B—N-filler.

FIG. 7C depicts a surface of an epoxy composite containing 20 wt % of 4 μm B—N-filler.

FIG. 7D depicts a surface of an epoxy composite containing 30 wt % of 4 μm B—N-filler.

FIG. 8 depicts a mechanism of coupling with a coupling agent.

FIG. 9 depicts the effect of the coupling agent concentration on thermal conductivity.

FIG. 10A depicts the effect of the B—N content and size on the dielectric constant of B—N-filled dielectrics.

FIG. 10B depicts the effect of the B—N content and size on the dissipation factor of B—N-filled dielectrics.

FIG. 11 depicts the effect of the B—N content and size on the glass transition temperature of B—N-filled dielectrics.

FIG. 12A depicts the effect of the B—N content and size on the coefficient of thermal expansion of B—N-filled dielectrics below the glass transition temperature.

FIG. 12B depicts the effect of the B—N content and size on the coefficient of thermal expansion of B—N-filled dielectrics above the glass transition temperature.

FIG. 13 depicts the effect of the B—N content on the moisture absorption of B—N-filled dielectrics.

FIG. 14 depicts the coating of a thermal conductive dielectric varnish onto a metal carrier.

FIG. 15 depicts the structure of a thermal conductive dielectric coated metal-plate.

### DETAILED DESCRIPTION

Reference will now be made in detail to a particular embodiment of the invention, examples of which are also provided in the following description. Exemplary embodiments of the invention are described in detail, although it will be apparent to those skilled in the relevant art that some features that are not particularly important to an understanding of the invention may not be shown for the sake of clarity.

Furthermore, it should be understood that the invention is not limited to the precise embodiments described below, and that various changes and modifications thereof may be effected by one skilled in the art without departing from the spirit or scope of the invention. For example, elements and/or features of different illustrative embodiments may be combined with each other and/or substituted for each other within the scope of this disclosure and appended claims. In addition, improvements and modifications which may become apparent to persons of ordinary skill in the art after reading this disclosure, the drawings, and the appended claims are deemed within the spirit and scope of the present invention.

A thermal conductive dielectric coated metal-plate includes a metal carrier, and a partially cured dielectric layer coated to the metal carrier. The dielectric layer includes an epoxy resin, a filler, and a coupling agent. A thermal conductive dielectric coated metal-plate having a high thermal conductivity may be obtained by maximizing the formation of conductive paths and/or minimizing thermal barriers. Maximizing the formation of conductive paths may be facilitated by including in the dielectric a high thermal conductive filler. Minimizing thermal barriers may be facilitated by using a coupling agent to modify the filler surface, which may lead to a better interaction with the polymer matrix.

Metal Carrier

The metal carrier may have a thickness ranging from 10 micrometers to 5 millimeters, and may be later imaged to produce a circuit layer or function as a heat sink. The metal carrier may include a high thermal conductive metal, such as copper, aluminum, iron, and combinations thereof. The metal carrier may include a surface treatment to improve heat dissipation and/or to enhance adhesion with the dielectric layer. A thermal conductive dielectric coated metal-plate having a metal carrier may offer the advantages of easy handling and transportation, and may provide better flexibility for the fabrication of multi-layer thermal conductive PCBs.

Filler Type

A high thermal conductive filler may be used to help maximize the formation of conductive paths in a dielectric material. The filler may also include multiple types of high thermal conductive fillers in combination. Materials with a perfect lattice or crystal structure may offer higher thermal conductivity, as they allow for less scattering of phonons due to lattice defects. Examples of high thermal conductive fillers include boron nitride (“B—N”), aluminium nitride (“Al—N”), beryllium oxide, alumina, silicon nitride, silicon carbide, and combinations thereof.

In one example, hexagonal boron nitride may be used as a filler, as it possesses an intrinsic high thermal conductivity of 270-300 W/m-k, a soft lubricious surface as a result of its graphitic crystal structure, and a low dielectric constant. The high intrinsic thermal conductivity may have a positive effect on enhancing the thermal conductivity of traditional PCB materials. Moreover, boron nitride has a hardness that is about ten times lower than that of aluminium oxide, and that is about five times lower than that of aluminium nitride and beryllium oxide. Consequently, these material properties may produce a highly thermal conductive dielectric layer that also has good toughness and that is less susceptible to thermal expansion mismatch. As described below in Example 3 and Table 1, B—N-filled dielectric layers can exhibit higher conductivities than Al—N-filled dielectrics.

Filler Size

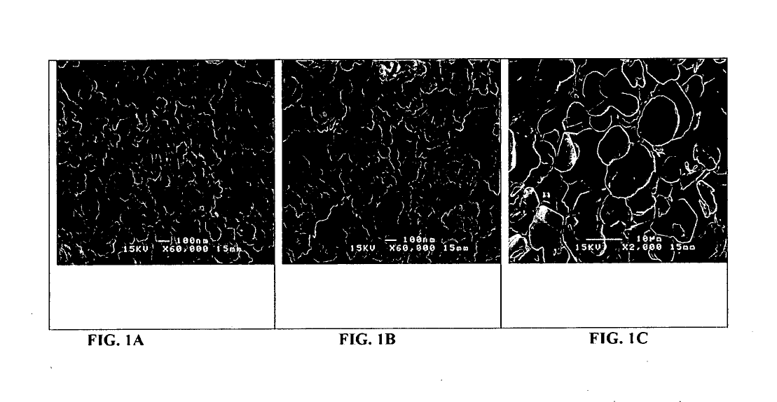

The size of the filler may range from 50 nanometers to 200 micrometers. Different sizes of fillers, such as bimodal and multi-modal fillers, may also be used. Examples of sub-micron-sized fillers include 53 nm and 0.15 μm B—N filler available from Zibo ShineSo. Examples of micro-sized fillers include 4 μm B—N filler available from Momentive Performance Materials Quartz. The size distribution and SEM images of 53 nm, 0.15 μm, and 4 μm boron nitride filler are depicted in FIGS. 1A to 1C, respectively. In these images, the sub-micron sized boron nitrides are irregular in shape, while the micro-sized boron nitride is in the form of flakes.

Heat is transported in non-metals by the flow of phonons, the quantum of lattice vibrational energy. Various types of phonon scattering processes, such as phonon-phonon scattering, boundary scattering, and defect or impurity scattering, are believed to be the source of thermal resistance in a non-metal. Minimisation of thermal resistance provides an increase in thermal conductivity. The use of a larger sized boron nitride filler may help to improve thermal conductivity of the dielectric layer by reducing the interfacial phonon scattering between epoxy matrix and B—N filler, since the larger sized filler has lower surface to volume ratio.

On the other hand, the aspect ratio of the filler may be more considerable and may dictate the conductivities of a composite, because fillers with large aspect ratios may easily form bridges among themselves, which are known as a conductive network. The formation of random bridges or networks from conductive particles may facilitate electrons and phonons transfer, which may lead to high conductivities. Consequently, the high aspect ratio of flake-like B—N filler particles may exhibit the bridging phenomenon, which may assist in the formation of conductive network.

Filler Content

The filler may be present in the dielectric layer at a concentration of from 10 weight percent (wt %) to 50 wt %. For example, the dielectric layer may contain 10 to 30 wt % of boron nitride filler. The upper limit may be constrained by the comparatively high viscosity of a varnish used to form the dielectric layer. The lower limit is determined by the amount of filler needed to provide a thermal conductivity of more than 1 W/m-K, without sacrificing other material properties. Preferably, the dielectric layer contains 20 to 25 wt % of boron nitride filler.

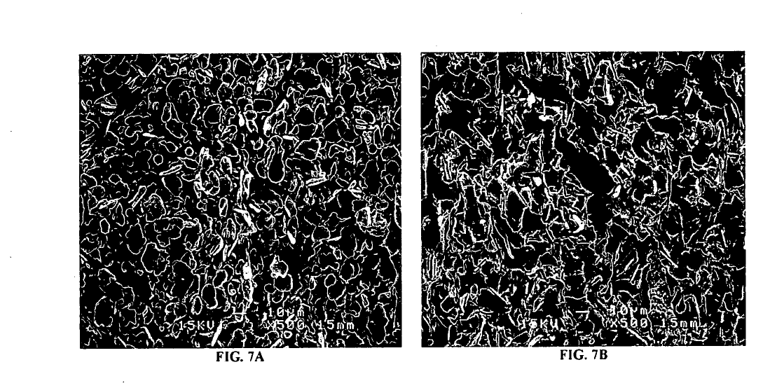

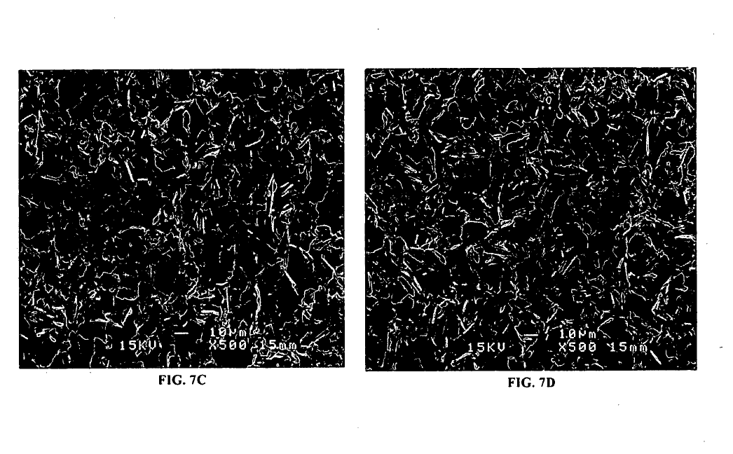

SEM micrographs of B—N filler and of the surfaces of epoxy composites containing various contents of B—N filler are depicted in FIGS. 7A to 7D. FIG. 7A depicts a 4 μm B—N filler. FIG. 7B depicts a surface of an epoxy composite containing 10 wt % of 4 μm B—N filler, FIG. 7C depicts a surface of an epoxy composite containing 20 wt % of 4 μm B—N filler, and FIG. 7D depicts a surface of an epoxy composite containing 30 wt % of 4 μm B—N filler. While the figures cannot be used to determine thermal conductive pathways or networks, the composite fracture surfaces revealed good interfacial adhesion between the B—N filler and the epoxy matrix. The smooth interfaces between the filler and the resin are believed to significantly contribute to the high thermal conductivity values of the composites, as poor interfacial adhesion can lead to strong scattering of heat energy at the filler-matrix interface.

Characterization

Thermal conductivity may be measured on an Anter Flashline 3000 at room temperature. A flash method may be used with a high speed Xenon discharge pulse source directed to the top face of the specimen to increase the temperature of the specimen by ΔT as a function of time and to obtain the values of the thermal diffusivity α and specific heat capacity Cₚ. Thermal conductivity can be calculated by the following equation:

K=αCₚρ (1)

where ρ is the density of the specimen.

While not being bound by theory, the effects on thermal conductivity of varying the size and the percentage of boron nitride may be explained by the modified Bruggeman theory for the thermal conductivity. This modified model takes into account the correlations between the positions of the particles and their multipolar polarisabilities. When the dispersed filler is much more conducting than the matrix, the model can be represented as:

$$\frac{{K}_{c}}{{K}_{m}} = \frac{1}{{( 1 - f )}^{3 ( 1 - α ) ( 1 + 2 α )}} \qquad ( 2 )$$

where K_{c} is the thermal conductivity of the B—N-filled dielectric composite, Kₘ is the thermal conductivity of the epoxy resin matrix, f is the volume fraction of the B—N filler, and α is a non-dimensional parameter that is inversely proportional to the radius of the dispersed B—N. From equation 2, it can be seen that the higher the volume fraction f of the B—N, the higher the thermal conductivity of the B—N-filled dielectric K_{c} will be.

Coupling Agent

The dielectric layer may include a coupling agent. The coupling agent may be used to minimize the thermal barrier, to ensure good dispersion, and/or to improve the interface between the filler and the matrix. Examples of coupling agents include silane. An example of silane is 3-glycidoxypropyltrimethoxysilane. For example, 0.5 to 5 percent of the coupling agent with respect to the weight of boron nitride may be used to coat the surface of boron nitride and enhance its interaction with the epoxy matrix. Preferably, 1 to 2 weight percent of the coupling agent may be used.

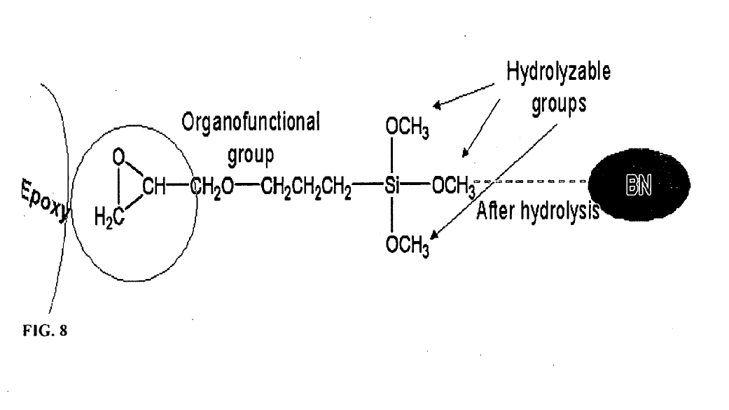

The coupling agent may include two different functional groups within the molecule, where one functional group interacts with the polymer matrix, and the other functional group interacts with the filler. For example, a coupling agent may include a hydrolysable group and an organofunctional group. An example of this type of coupling agent is depicted in FIG. 8. A hydrolysable group may form a chemical bond with the filler, while an organofunctional group may form a chemical bond with the polymer matrix. These functional groups may enable the coupling agent to function as an intermediary in bonding the organic and inorganic components, which normally do not bond with each other. This improved bonding may lead to increased thermal conductivity by minimising the heat scattering at the interface.

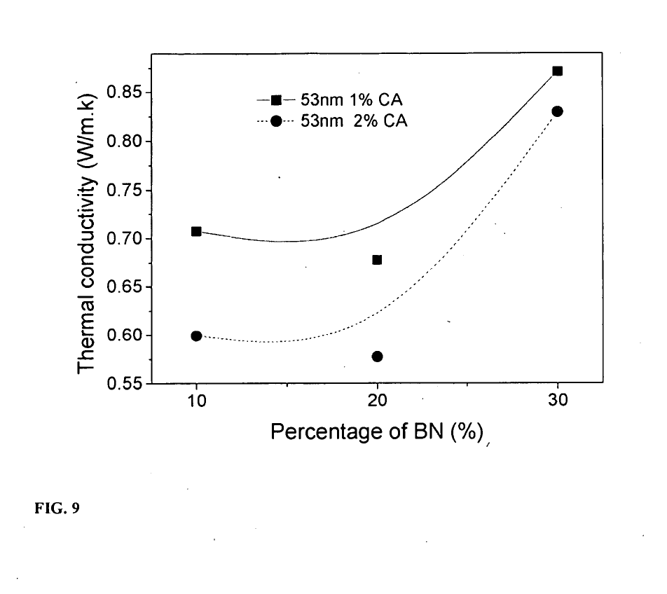

As described in Example 6 and depicted in FIG. 9, the presence and concentration of the coupling agent affected the thermal conductivity of the dielectric layer. In this example, 1% of the coupling agent was sufficient to enhance the thermal conductivity of the dielectric layer. As the concentration of the coupling agent in the filler was increased, phonon scattering at the interface was minimized, enhancing the thermal conductivity. This enhancement, however, showed a maximum with respect to coupling agent concentration. A further increase of the coupling agent beyond the amount corresponding to the maximum may have led to a thick coating on the B—N filler that became a thermal barrier, causing the thermal conductivity to decrease. Improved filler dispersion with an appropriate lower concentration of coupling agent may contribute to better thermal conductivity that may help to build a uniform thermal conductive network.

Electrical Properties

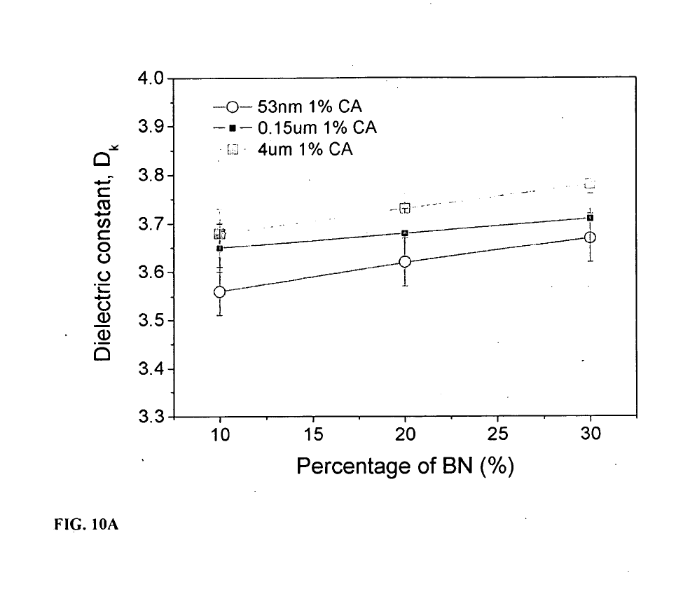

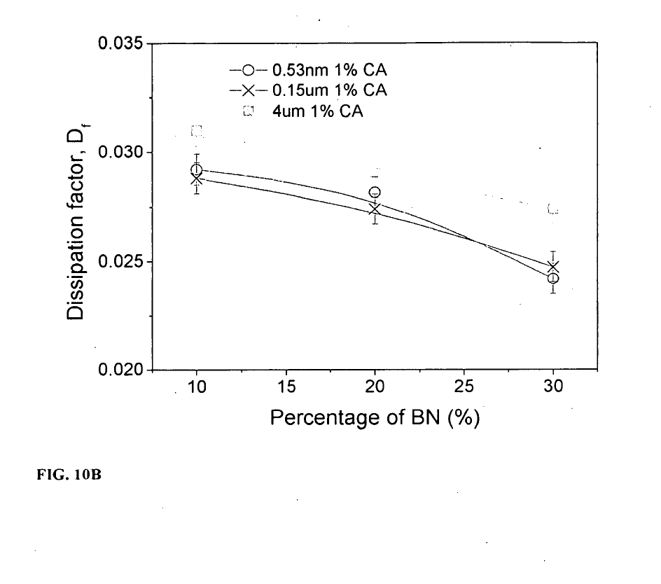

Electrical properties of dielectric layer may not be significantly affected by incorporating a high thermal conductive filler. The dielectric constant of an insulating material is a measure of the degree to which an electromagnetic wave has slowed down as it travels through the material. In one example, the dielectric constant of pure epoxy is about 3.56, while the dielectric constant of pure boron nitride is in the range of 3.9 to 4.1. The effect of the B—N filler content and the size of the filler on the dielectric constant is described in Example 7 and depicted in FIG. 10A. These results showed a general trend of the dielectric constant increasing with the increase of filler content and filler size; however, boron nitride did not significantly affect the dielectric constant of the dielectric concurrently.

Dissipation factor is a measure of the loss-rate of the electromagnetic field travelling through a dielectric layer. Similar to the dielectric constant, a lower dissipation factor correlates with a lower amount of energy is absorbed or lost. The effect of the B—N filler content and the size of the filler on the dissipation factor is described in Example 7 and depicted in FIG. 10B. These results showed a general trend of the dissipation factor decreasing with the increase of filler content

Thermal Mechanical Properties

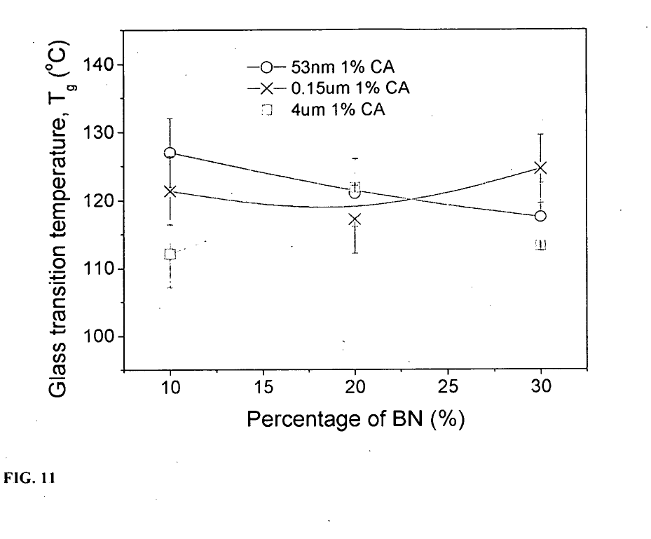

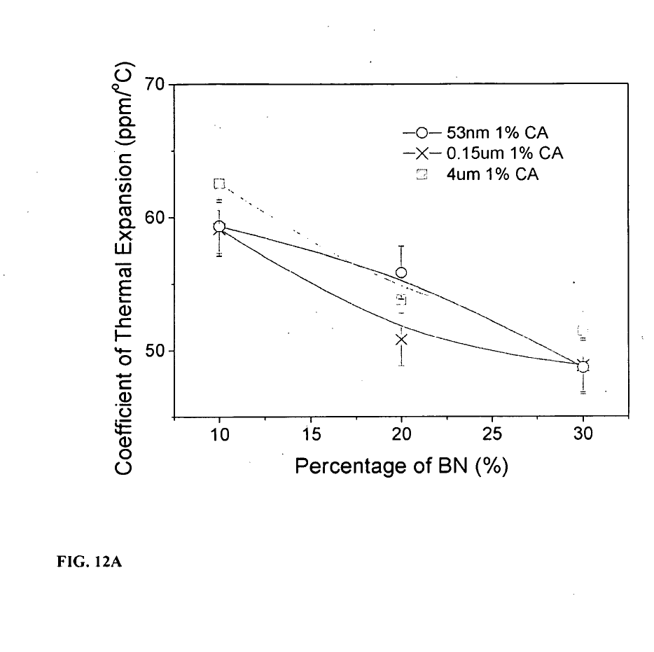

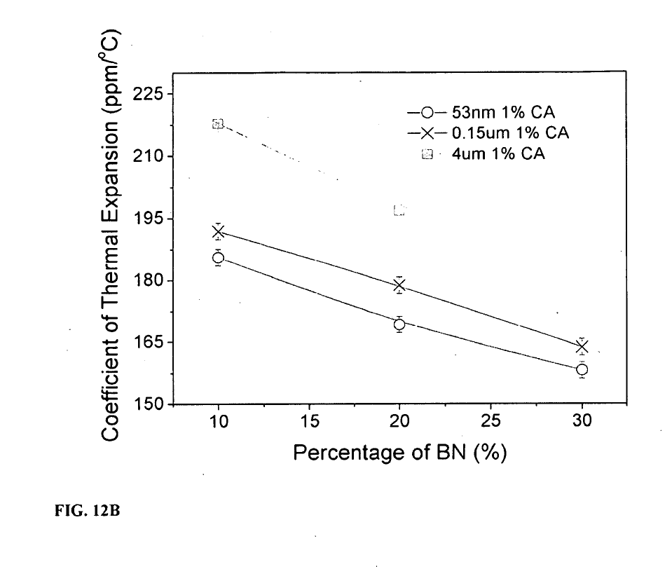

Thermal properties of the filler-added dielectric layer may be enhanced by adding a high thermal conductive filler. The glass transition temperature (T_{g}) is the temperature at which the mechanical properties of amorphous polymer change from the state of glass (brittle) to the state of rubber (elastic). Materials used for PCBs typically undergo a property change at the glass transition temperature, whereby the coefficient of the thermal expansion swiftly rises from a relatively low value to a very high value. This change is not typically desirable, as it imposes stress on the PCBs when they are subjected to high temperature stress during manufacture, assembly, or use. Since high T_{g} is needed for MCPCB applications where high power consumption is required, the B—N filled dielectric layer preferably includes an epoxy matrix having a high T_{g} for the neat epoxy resin. The effect of the B—N filler content and the filler size on the T_{g} of B—N filled dielectric layers is described in Example 8 and depicted in FIG. 11. These results demonstrate the high T_{g}'s of the B—N filled dielectric layers.

Coefficient of thermal expansion (CTE) is a measure of the rate of change of the thermal expansion of a dielectric layer. A low CTE is preferred, because a material with high z-axis coefficient of thermal expansion will tend to induce stress on a material such as a PCB. In one example, the CTE below the T_{g} and above the T_{g} for a neat epoxy were 63 and 216 ppm/° C., respectively. The effect of the B—N filler content and the filer size on the CTE of B—N filled dielectric layers is described in Example 8 and depicted in FIGS. 12A and 12B. These results demonstrated a general decreasing trend of the CTE with increasing content of the boron nitride.

Method of Making

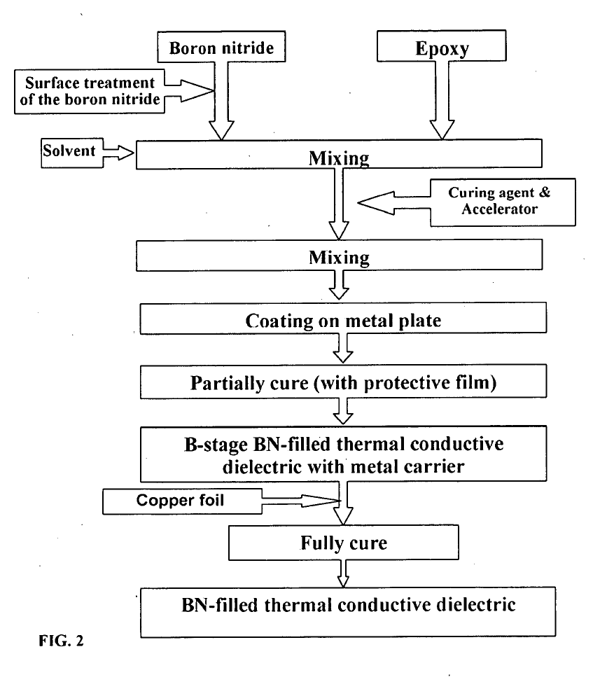

An example of a method of making a B-stage B—N-filled thermal conductive dielectric coated metal-plate is described in Example 1 and depicted in FIG. 2. The dielectric layer can include any thermosetting polymer, such as an epoxy filled with a high thermal conductive filler.

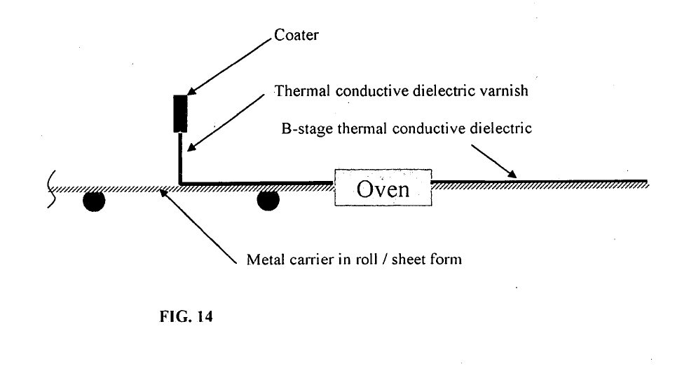

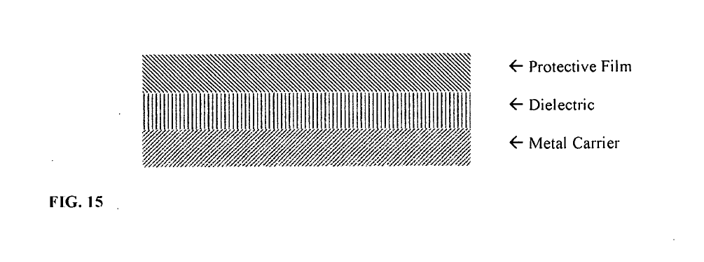

A method of making a B-stage B—N filled thermal conductive dielectric coated metal-plate may include coating a metal carrier with a high thermal conductive dielectric material. A thermal conductive dielectric in a varnish stage may be coated on one side of a metal carrier, and then dried to a B-stage (partially cured) condition. The coating may have a thickness from 20 micrometers to 500 micrometers before and after curing. Screen printing, roller coating, curtain coating, or other suitable techniques may be used to coat the varnish onto the metal carrier. The coating may be performed, for example, in a continuous roll-to-roll form or in a sheet form. An example of a coating technique is depicted in FIG. 14. The exposed side of the resulting dried thermal conductive dielectric in its B-stage may be covered with a protective film, as depicted in FIG. 15, which may be discarded in later PCB fabrication processes.

A B-stage thermal conductive dielectric coated metal-plate may be pressed with a second metal carrier, and may then be cured to form a C-stage (fully cured) thermal conductive dielectric or multi-layer PCB, as described in Example 2 and depicted in FIG. 2. The second metal carrier may be as described for the initial metal carrier. The resulting thermal conductive dielectric coated-metal plate or multi-layer PCB may have high values of thermal conductivity, glass transition temperature, thermal stability, electrical strength and water resistance.

The following examples are provided to illustrate one or more preferred embodiments of the invention. Numerous variations may be made to the following examples that lie within the scope of the invention.

### EXAMPLES

### Example 1

### Preparation of a B-stage B—N-Filled Thermal Conductive Dielectric Coated Metal-Plate

The following system was chosen for its low viscosity to ensure good dispersion and improved interface between filler and epoxy matrix: brominated difunctional epoxy EP8008 and tetrafunctional epoxy EP1031 (both from Huntsman) were used as epoxy resin components. Dicyandiamide (from Neuto Products) was used as a hardener, and 2-methylimidazole (from Tokyo Kasei Kogyo) was used as an accelerator. Shin-Etsu KBM-403, 3-glycidoxypropyltrimethoxysilane was used as coupling agent. Boron nitride (from Zibo ShineSo and Momentive Performance Materials Quartz) was used as the filler. The B—N filler had a size of either,53 nm, 0.15 μm or 4 μm (AC6004), as depicted in FIGS. 1A to 1C, respectively.

A process flow for fabricating a B—N-filled thermal conductive dielectric coated metal-plate is depicted in FIG. 2. In this example, the desired volume fraction of boron nitride was mixed with a 1% (with respect to the weight of boron nitride) solution of KBM-403. The filler was dried and then added into the liquid epoxy resin components and mixed at different periods of time. A mixer was employed to achieve homogenized particle dispersion without evident sedimentation of the filler. The resulting B—N-filled varnish was coated on copper foil and dried at about 110° C. in an oven for about 5 min to remove the entrapped air and solvent. The process for preparing a B-stage aluminium nitride-filled dielectric was the same as that of the boron nitride, except that the boron nitride was replaced with aluminium nitride.

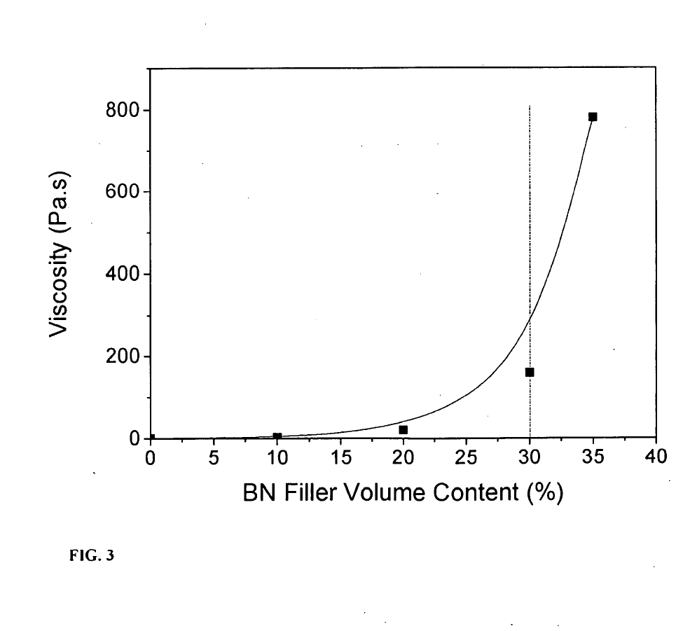

The Theological properties of the B—N-filled composite were measured. As shown in FIG. 3, the viscosity of the B—N-filled varnish became extremely high when the filler content exceeded 30%, which may lead to micro-voids and bubbles during the vacuum curing process. Consequently, dielectrics containing 10%, 20% and 30% by volume of B—N filler were chosen for further processing and testing.

### Example 2

### Preparation of a C-Stage B—N-Filled Thermal Conductive Dielectric Coated Metal-Plate

In this example, the C-stage B—N-filled thermal conductive dielectric coated metal-plate was fabricated by laminating the B-stage thermal conductive dielectric coated copper foil of Example 1 with another copper foil in a vacuum presser at about 175° C. for about 2.5 hours. The process for preparing a C-stage aluminium nitride-filled dielectric coated metal-plate was the same as that of the boron nitride, except that the boron nitride was replaced with aluminium nitride.

### Example 3

### Thermal Conductivity of B—N Filler-Loaded v. Al—N Filler-Loaded Dielectric Layers

In this example, the thermal conductivities of the filled thermal conductive dielectric layers of Example 2 were measured. As shown in Table 1, the B—N-filled dielectric layers exhibited higher thermal conductivity than the Al—N-filled dielectric layers for the loadings tested. It was attributed to boron nitride formed thermally conductive networks at lower filler content than aluminium nitride and boron nitride's relatively high inherent thermal conductivity in comparison with aluminium nitride. Consequently, a comparatively low amount of B—N was enough to achieve a high thermal conductivity of the filler-added dielectric layer.

TABLE 1
Comparison of thermal conductivity of different
filler-loaded thermal conductive dielectric layers

| | | Thermal Conductivity of |
|---|---|---|
| | Thermal Conductivity of | Aluminium Nitride |
| Percentage of filler | Boron Nitride (W/m-K) | (W/m-K) |
| 10% | 0.71 | 0.51 |
| 20% | 0.71 | 0.54 |
| Pure filler powders | 250-300 | 260 |

### Example 4

### Effect of Filler Content on Thermal Conductivity of B—N-Filled Dielectric Layer

SEM micrographs of the surfaces of B—N-filled epoxy composites are depicted in FIGS. 7A to 7D. The improvement of thermal conductivity was significant when the B—N content increased from 0% to 30%.

It is believed that more boron nitride particles may help to shorten the low thermal conductive path of the epoxy matrix, and to establish a high thermal conductive network for heat conduction. Experimental results have confirmed that a higher percentage of boron nitride can yield a higher thermal conductivity of the dielectric layer.

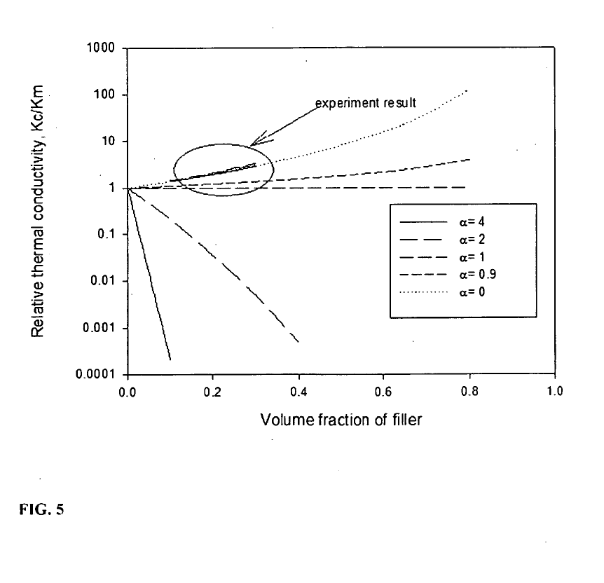

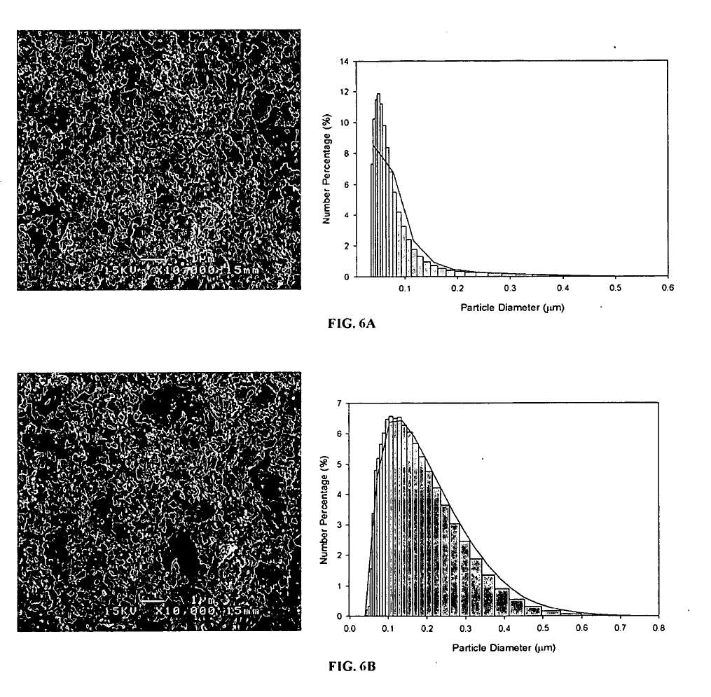

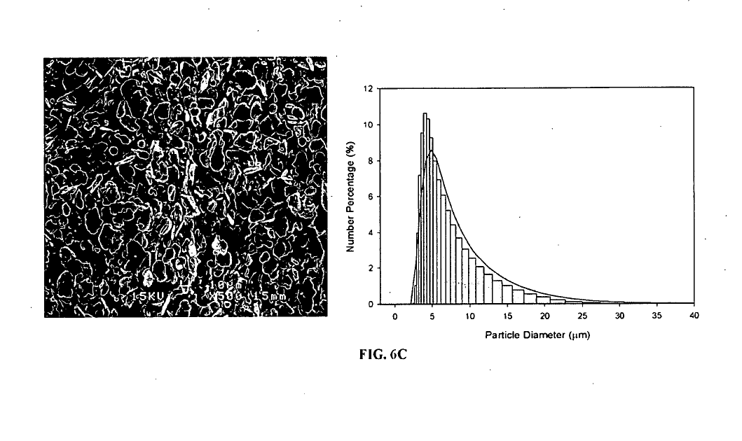

A plot of equation (2) with the experimental data is depicted in FIG. 5. The results match well with the Bruggeman model. It was observed that for α>1, the thermal conductivity decreased with the increasing volume fraction; while for α<1, the thermal conductivity increased with the increasing volume fraction. Since α is inversely proportional to the size of B—N filler, it can be considered as the sensitivity of the filler-loaded dielectric layer to the interfacial thermal resistance.

### Example 5

### Effect of Filler Size on Thermal Conductivity of B—N-Filled Dielectric Layers

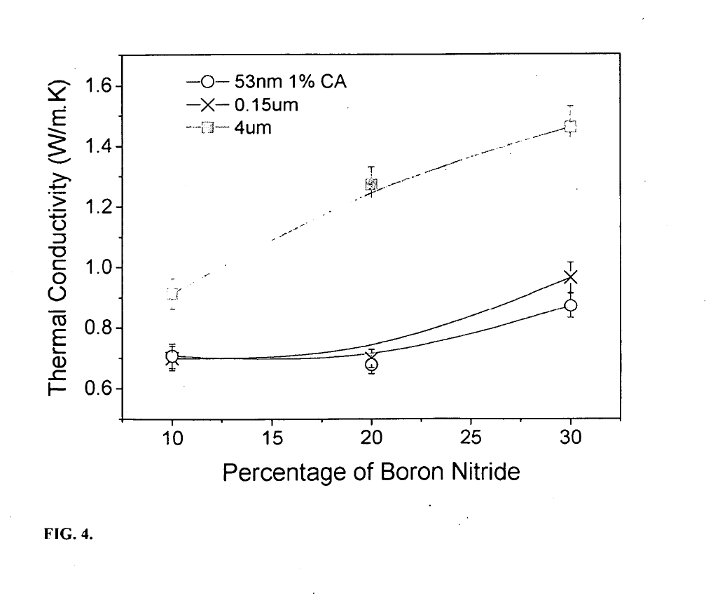

The thermal conductivities of B—N filled dielectric layers with varying filler powder sizes and filler percentages of boron nitride were measured. As depicted in FIG. 4, for any given filler percentage of boron nitride, the dielectric layer with the larger powder size of boron nitride always exhibited a higher thermal conductivity. In addition, for any given filler powder size of boron nitride, a higher filler percentage of boron nitride also always exhibited a higher thermal conductivity. It is noted that more boron nitride filler and/or larger boron nitride filler particles helped to shorten the low thermal conductive path (i.e. epoxy matrix) and to establish a high thermal conductive network for heat conduction. It is also noted that a larger powder size gave a lower surface to volume ratio, and lowered the interfacial phonon scattering for a given weight of the filler, which yielded a higher thermal conductivity.

Referring again to FIG. 4, the thermal conductivity increased swiftly at a B—N fraction above 20% for the sub-micron B—N-filled epoxy composite. When the percentage of boron nitride was at about 20%, a critical concentration was reached where boron nitride particles started highly contacting with each other, which helped to expedite the rising rate of the thermal conductivity of boron nitride. Once sub-micron sized boron nitrides were in contact with each other, the actual size of the agglomerate became larger, which helped to expedite the increased rate of the thermal conductivity with the increasing of the boron nitride percentage.

### Example 6

### Effect of Coupling Agent on Thermal Conductivity

The effect of the coupling agent on the thermal conductivity of the B—N-filled dielectric layer was measured. As depicted in FIG. 9, 1% of the coupling agent was sufficient enough to enhance thermal conductivity, while 2% of the coupling agent resulted in an excessive coating of the filler.

### Example 7

### Electrical Properties of the B—N-Filled Dielectric Layers

The effect of the filler content on the dielectric constant with different sizes of B—N-filler was measured, and the results are depicted in FIG. 10A. The results showed that a larger size of B—N filler tended to yield a higher dielectric constant. Also, for a given size of B—N filler, higher B—N filler content also tended to yield a higher dielectric constant. Yet, the overall resultant dielectric constant of the dielectric was kept below 4.5, which is the typical value for PCB materials.

The effect of the filler content on the dissipation factor with different sizes of B—N-filled dielectric layers was measured, and the results are depicted in FIG. 10B. The results showed a general trend of the dissipation factor decreasing with the increase of filler content. Since the boron nitride filler had a dissipation factor as low as 0.0002, in comparison to that of the epoxy, which was about 0.0327, the filler helped to lower the dissipation factor of the composite.

### Example 8

### Thermo-Mechanical Properties of the B—N-Filled Dielectric Layers

Coefficient of thermal expansion (CTE) and glass transition temperature T_{g} measurements were performed on a Perkin-Elmer thermal mechanical analyser (TMA). These tests complied with the IPC-TM-650 2.4.24C standard method for determining samples mounted on the TMA, which was heated from 23° C. to 175° C. at a heating rate of 10° C./min. To comply with IPC-TM-650 2.5.5.2A, the dielectric constant Dₖ and dissipation factor D_{f} was detected by a HP4285A precision LCR Meter at room temperature, with 1 MHz frequency and 1 V output voltage. The CTE was determined from the slope of a thermal expansion versus temperature plot (not shown), and the average values were determined for at least two different samples.

A plot of the T_{g} as a function of B—N filler content is depicted in FIG. 11. The results demonstrated that all of the T_{g}′s of the B—N filled dielectric layers were higher than that of neat epoxy, which was around 103° C. This is believed to be due to the comparative stiffness of the B—N fillers restricting the mobility of the adjacent epoxy matrix, which led to higher glass transition temperatures for the composites. It also implied a good interfacial interaction between the B—N filler and the epoxy matrix. On the other hand, it is possible that the filler surface acted as a catalyst that affected the molecular architecture of the cross-linked epoxy.

Plots of CTE as a function of B—N content for a variety B—N filler sizes below and above the T_{g} are depicted in FIGS. 12A and 12B, respectively. The results demonstrated a general decreasing trend of the CTE with increasing content of the boron nitride. Meanwhile, smaller B—N filler showed a greater improvement on the CTE, especially when measured above the T_{g}. This may be contribute to the increased interfacial interaction between the filler and the epoxy in the rubber phase, thereby better restraining the thermal expansion.

### Example 9

### Moisture Absorption Properties of the B—N-Filled Dielectric Layers

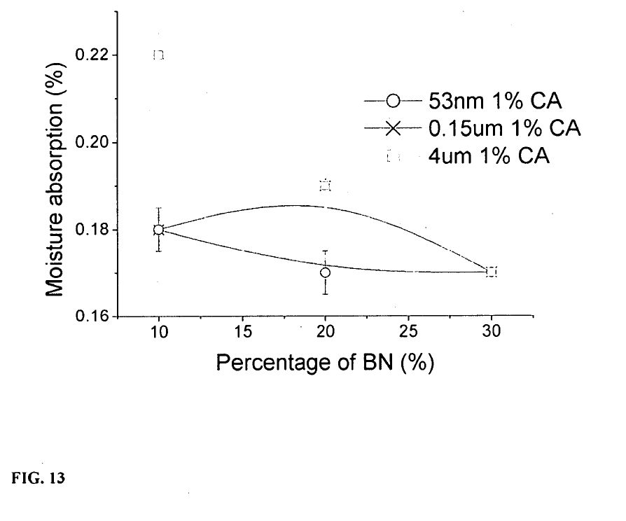

The effect of the filler content on the moisture absorption with different sizes of B—N-filler was measured, and the results are depicted in FIG. 13. The results showed a significant decrease in moisture absorption with the addition of filler.

### Example 10

### Summary of Characterization Tests

Various characterisation tests were conducted on the B—N-filled dielectric layer, the results of which were compared with pure epoxy and summarized in Table 2. The calculated data were based on a 30% B—N-filled dielectric layer.

TABLE 2
Summary of the characterization tests on B-N-filled dielectric layers

| | | Size of B-N-filled dielectric materials | | |
|---|---|---|---|---|
| | Pure epoxy | 53 nm | 0.15 μm | 4 μm |
| Thermal | 0.38 | 0.87 | 0.96 | 1.45 |
| conductivity | | (Improved 129%) | (Improved 153%) | (Improved 282%) |
| (W/m · K) | | | | |
| Dk | 3.56 | 3.67 | 3.71 | 3.78 |
| | | (Increased 3%) | (Increased 4%) | (Increased 6%) |
| Df | 0.0327 | 0.0242 | 0.0247 | 0.0274 |
| | | (Improved 26%) | (Improved 24%) | (Improved 16%) |
| Tg (° C.) | 103.4 | 117.5 | 124.6 | 113.2 |
| | | (Improved 14%) | (Improved 21%) | (Improved 9%) |
| CTE (Pre-T_{g}) | 63.39 | 48.71 | 48.86 | 51.46 |
| (ppm/° C.) | | (Improved 23%) | (Improved 23%) | (Improved 19%) |
| CTE (Post-T_{g}) | 216.14 | 158.16 | 163.66 | 183.33 |
| (ppm/° C.) | | (Improved 27%) | (Improved 24%) | (Improved 15%) |
| Moisture | 0.33 | 0.17 | 0.17 | 0.17 |
| absorption (%) | | (Improved 48%) | (Improved 48%) | (Improved 48%) |

As shown, the micro-sized boron nitride (4 μm) distinctively out-performed the other sizes in improving the thermal conductivity. The sub-micron-sized (0.15 μm and 53 nm) B—N fillers were more effective in improving the electrical and the thermal mechanical properties, such as the dissipation factor, the dielectric constant and the CTE. This is likely due to the larger particle size of the B—N filler having a higher maximum packing density, which provided a large number of conductive networks in the composite, to fulfill both path dependent and bulk properties. Moreover, sample preparation may have led to different particle distributions in the matrix, and may have led to variation in the number of conducting paths and in the particle density along the heat-flow paths that affected the thermal conductivity and other physical properties of the composite.

While the examples of the dielectrics have been described, it should be understood that the dielectric coated metal-plates are not so limited and modifications may be made. The scope of the dielectric coated metal-plate is defined by the appended claims, and all devices that come within the meaning of the claims, either literally or by equivalence, are intended to be embraced therein.

What is claimed is:

1. A thermal conductive dielectric coated metal-plate, comprising:
a metal carrier; and
a partially cured dielectric layer coated to said metal layer,
wherein said dielectric layer comprises an epoxy resin, a filler, and a coupling agent.

2. The metal-plate of claim 1, wherein said carrier comprises a high thermal conductive metal selected from the group consisting of copper, aluminum, iron, and combination thereof.

3. The metal-plate of claim 1, wherein said carrier has a thickness of from 10 micrometers to 5 millimeters.

4. The metal-plate of claim 1, wherein said filler comprises at least one member selected from the group consisting of boron nitride, aluminium nitride, beryllium oxide, alumina, silicon nitride, and silicon carbide.

5. The metal-plate of claim 4, wherein said filler has an average size of from 50 nanometers to 200 micrometers.

6. The metal-plate of claim 4, wherein said dielectric comprises 10 to 50 weight percent of said filler.

7. The metal-plate of claim 1, wherein said coupling agent comprises 3-glycidoxypropyltrimethoxysilane.

8. The metal-plate of claim 7, wherein said dielectric comprises 0.5 to 5 weight percent of said coupling agent.

9. The metal-plate of claim 1, further comprising a protective layer coated to said dielectric layer.

10. The metal-plate of claim 1, further comprising a dielectric constant of at most 4.0.

11. The metal-plate of claim 1, further comprising a dissipation factor of at most 0.0275.

12. The metal-plate of claim 1, further comprising a glass transition temperature of at least 113° C.

13. The metal-plate of claim 1, further comprising a coefficient of thermal expansion below the glass transition temperature of at most 52 ppm/° C.

14. The metal-plate of claim 1, further comprising a coefficient of thermal expansion above the glass transition temperature of at most 184 ppm/° C.

15. The metal-plate of claim 1, further comprising a moisture absorption of at most 0.18 percent.

16. A method of making a thermal conductive dielectric coated metal-plate, comprising:
mixing a filler with a coupling agent;
adding said filler to an epoxy resin to form a varnish;
coating said varnish on a metal carrier; and
curing said varnish.

17. The method of claim 16, further comprising surface treating said filler prior to mixing with said coupling agent.

18. The method of claim 16, wherein said epoxy resin is formed from a brominated difunctional epoxy and a tetrafunctional epoxy.

19. The method of claim 16, wherein said curing comprises drying said varnish to a partially cured condition.

20. The method of claim 16, further comprising adding a layer of protective film.
